(19) United States
(12) Patent Application Publication
(10) Pub. No.: US 2026/0170139 A1
(43) Pub. Date: Jun. 18, 2026

(54) MULTI-TENANCY OF PLATFORM CONFIGURATION REGISTERS IN A MULTI-BANK VIRTUAL TRUSTED PLATFORM MODULE

(71) Applicant: International Business Machines Corporation, Armonk, NY (US)

(72) Inventors: Patricia Maria SAGMEISTER, Adliswil (CH); Wojciech OZGA, Birmensdorf (CH); Tamas Visegrady, ZURICH (CH)

(21) Appl. No.: 18/981,529

(22) Filed: Dec. 14, 2024

(51) Int. Cl. G06F 21/57; G06F 21/60; H04L 9/08

(52) U.S. Cl. CPC G06F 21/57; G06F 21/602; H04L 9/0861; G06F 2221/033

(57) ABSTRACT

In some implementations, a storage device may receive a first request, associated with a first application, to perform a first platform configuration register (PCR) operation. The storage device may perform the first PCR operation within a first bank of PCRs associated with the first application, the first bank of PCRs being associated with a first salt number. The storage device may receive a second request, associated with a second application, to perform a second PCR operation. The storage device may perform the second PCR operation within a second bank of PCRs associated with the second application, the second bank of PCRs being associated with a second salt number and being stored within a same data structure as the first bank of PCRs.

### BACKGROUND

Platform configuration registers (PCRs) are hardware registers that store measurements of a software environment. For example, a PCR may store measurements associated with one or more of a basic input/output system (BIOS) or unified extensible firmware interface (UEFI) configuration, a bootloader, a kernel state, or an application hash, among other examples. PCRs may be located in a trusted platform module (TPM).

A computing device may use a PCR value as a security feature to verify integrity (e.g., a lack of tampering) for the computing device. For example, as the computing device boots, the computing device may compute hash values of one or more sources of measurements and extend the hash values to a PCR. The computing device may verify integrity by comparing the hash value and a PCR value stored at the TPM. In this way, if malware or other foreign software has altered the source of measurements (e.g., the bootloader), the PCR value calculated by the computing device will not match an expected value of the PCR (e.g., a value stored at the TPM).

In some examples, a remote system (e.g., a virtual machine environment) may verify PCR values to confirm that a virtual machine is in a trusted state. In some examples, an application or computing system may request a signed report of PCR values from the TPM to support verification by an external entity.

### SUMMARY

In some implementations, a method comprises receiving a first request, associated with a first application, to perform a first platform configuration register (PCR) operation. The method also comprises performing the first PCR operation within a first bank of PCRs associated with the first application. The method also comprises receiving a second request, associated with a second application, to perform a second PCR operation. The method further comprises performing the second PCR operation within a second bank of PCRs associated with the second application, the second bank of PCRs stored within a same data structure as the first bank of PCRs.

In some implementations, a computer program product comprises one or more computer readable storage media and program instructions collectively stored on the one or more computer readable storage media. The program instructions comprise program instructions to receive a first request, associated with a first application, to perform a first attestation operation. The program instructions comprise program instructions to perform the first attestation operation within a first bank of registers associated with the first application. The program instructions comprise program instructions to receive a second request, associated with a second application, to perform a second attestation operation. The program instructions further comprise program instructions to perform the second attestation operation within a second bank of registers associated with the second application, the second bank of registers stored within a same data structure as the first bank of registers.

In some implementations, a system comprises one or more devices configured to receive a first request, associated with a first application, to perform a first platform configuration register (PCR) operation on a set of PCR values of a first bank of PCRs. The one or more devices are further configured to perform the first PCR operation within a first bank of PCRs associated with the first application. The one or more devices are further configured to receive a second request, associated with a second application, to perform a second PCR operation on a set of PCR values of the first bank and a second bank of PCRs, the second bank of PCRs stored within a same data structure as the first bank of PCRs. The one or more devices are further configured to refrain from performing the second PCR operation based at least in part on the second request indicating PCR values of multiple banks of PCRs.

### BRIEF DESCRIPTION OF THE DRAWINGS

FIGS. 1A-1D are diagrams of an example implementation described herein.

FIG. 2 is a diagram of an example implementation described herein.

FIG. 3 is a diagram of an example computing environment in which systems and/or methods described herein may be implemented.

FIG. 4 is a diagram of example components of one or more devices of FIGS. 1 and 2.

FIGS. 5-7 are flowcharts of example processes associated with a multi-tenancy of platform configuration registers (PCRs) in a multi-bank virtual trusted platform module (VTPM).

### DETAILED DESCRIPTION

The following detailed description of example implementations refers to the accompanying drawings. The same reference numbers in different drawings may identify the same or similar elements.

A computing device may use platform configuration registers (PCRs) to verify integrity of the computing device. For example, the computing device may provide a hash of measurements of the computing device to a trusted platform module (TPM) (e.g., one or more of a basic input/output system (BIOS) or unified extensible firmware interface (UEFI) configuration, a bootloader, a kernel state, or an application hash, among other examples). Before performing an operation, such as an update, bootup, or running an application, the computing device may perform a new measurement to provide to the TPM for comparison with the previously provided and stored PCR values. In this way, if malware has altered a measured characteristic of the computing device or if the computing device is otherwise in an error state, the TPM may provide an indication that the PCR value submitted by the computing device is not valid. The computing device may be unable to perform a secure task if the PCR is not valid, which may provide a layer of security for the computing device or protected information.

Cloud virtual platforms, such as virtual machines or containers, may use trusted platforms (e.g., TPMs) to provide tenants with digital signatures via collections of state-describing data structures (e.g., attestation quotes or certified timestamps). However, because trusted-platform APIs pre-date mass deployments of virtualization, extensions may be used to virtualize associated APIs. In some examples, a virtualization environment may route calls to single-instance remote servers or emulate single instances of them, and do not exploit multi-instance capabilities associated with virtualization.

In some aspects described herein, a system may digitally sign queries returned by virtualized trusted platforms utilizing multi-instance backends’ additional capabilities. In some aspects, the system may serve as a drop-in replacement for existing trusted-signature systems, with minimal host additions.

In some aspects, additional virtualization-specific safeguards may be used to improve security, which is not available in a single-instance virtualization. In this way, the system may mitigate security-problematic features of multi-instance trusted platforms. In some aspects, host code may be exploited to assist host-attestation solutions in ways that benefit virtualized host-software stacks.

Virtualizing trusted platform backends may be challenging since they have been designed to manage trust roots in dedicated, single-instance trusted platform modules (e.g., single-instance hardware, such as TPM chips, may serve as trust roots of attestation). While TPMs are a specific type of trusted platforms, this disclosure may use “TPM” herein as a generic term for trusted platforms for brevity. In other words, although examples described herein recite a “TPM,” the examples should be read as including other types of trusted platforms other than those specifically called a “TPM.”

Recognizing a demand for virtualization of massively parallel clients, typical on mainframe servers, as an example, some systems may us trust virtualization APIs where a shared, hardware-based trust point manages multiple (e.g., essentially an unlimited number) clients. When virtualizing multi-tenant trusted platforms, a scalable approach may maintain TPM-related data structures in hardware-managed, host-resident databases that are integrity-protected. Such non-malleable host-resident objects may then be mapped to standard APIs’ calls and structures using a modest amount of host-based code. To the rest of a system, responses appear as they would from a single, dedicated, standard-compliant trusted platform backend.

In some aspects, a virtualized host-resident TPM (“virtualized TPM”) state may be structured with the following fields, with only the highlighted few corresponding as-is to standard trusted platform structures: a system state that may be indicated as a cryptographic hash (e.g., the content of a PCR register from the TPM standard), a register identification (e.g., an index from a list of registers, and virtualized banks where multiple sets of registers are concurrently maintained. The virtualized banks may extend single-dimensional lists to their two-dimensional matrix equivalent as a virtualization step. A straightforward sample application could maintain the system-state evolution of a regular TPM register list, with different hash functions used by different banks, but using identical indexes for corresponding registers. In some aspects, the banks used in the virtualized TPM state may include an extended version of TPM banks, with considerably more banks than practical in any non-virtual TPM.

The virtualized TPM state may include one or more of a generation counter that is maintained for each register and incremented during updates (e.g., each update) or instance identifiers such as cryptographic salt fields may be added to differentiate between banks. Banks and register lists with identical salt numbers are considered parts of a same TPM-register set and are considered unrelated to other register sets with different salt numbers. In this way, the salt numbers may function as a third axis of virtualization, beyond the two-dimensional bank layout.

In some aspects, a generation counter may provide a convenient index to track histories of registers (e.g., each register) even if a standard TPM API view is restricted to a then-current state (the limitation of TPM APIs reflects the single-instance nature of the API). While generation counters provide little additional value for the backend itself, securely maintaining them together with regular fields allows efficient history tracking for TPM-facing code.

The virtualized TPM state may include tuples of the previously described entities. The virtualizing backend assigns salts (e.g., instance identifiers associated with different entities) the requesting host code providing bank and register index (and data to store to registers).

A single-dimensional array of states may be a standard TPM API representation for a set of measurements (e.g., a view TPM-aware applications perceive as a compliant API). In some aspects described herein, a system may use host-resident, integrity-protected object repositories to maintain tuples. Based at least in part on tuples’ contents not being sensitive, the tuples may be available to query and integrity protection is sufficient (e.g., confidentiality is not required. The system (e.g., the computing device) may use request-attached tuples as equivalents of a TPM call, and may return updated forms of the tuples or PCRs instead of updating a register collection inside the backend. Minimal new host code may be used to map simple register-to-tuple indirection transparently to TPM register management.

In some aspects, the system (including one or more computing devices) may use regular TPM services, or other comparable APIs, with a variant where digital signatures attest to a collection of tuples. Local TPMs (e.g., non-virtual TPMs or single-tenancy TPMs) may have API calls that use a caller-supplied quote (e.g., a template) describing which registers are to be signed, and a backend populates structures to sign from its then-current state of TPM registers. With generalized TPM APIs, the system may minimally extend query-template possibilities and restrict a quantity of additions. For example, the system may use query templates that do not directly reference virtualization, including in extended fields. In some aspects, the system may use query templates that supply a bitmask of registers to include in a signed response.

In some aspects, the system may map virtualization-unaware TPM-quoting queries to the system. The system may use an API to attach tuples that are referenced in the quote template (e.g., based at least in part on the backend not maintaining the tuples, but being able to verify integrity of the tuples).

In some aspects, to map from standard TPM APIs, the system may use the same quote-template structure and supply a corresponding set of tuples, with all referenced registers being associated with the same bank of the virtual TPM. These queries may be directly remapped from a single-bank view as equivalents of quotes from a single-instanced TPM. This mapping may increase a likelihood that all supplied TPM-state tuples belong to the same bank and instance identifiers. In other words, the strictest and simplest checking may increase a likelihood that all supplied structures correspond to the same application.

In some aspects, virtualization of the TPM may support additional query capabilities. In some aspects, virtualization of the TPM may allow for erroneous situations that are introduced by virtualizing the API. For example, the host may supply a list of tuples, instead of just using TPM-internal registers. In some aspects, the query may be rejected based at least in part on the query template referencing register indexes that are absent from the tuples attached to the request (e.g., an API-usage problem that does not arise from non-virtualized TPMs). In some aspects, the query may be rejected based at least in part on the collection of tuples attached to the request containing a mixture from different banks. This combination may arise if a malicious host code would try to mix multiple, nominally independent register lists, even if they all belong to the same caller.

In some aspects, the query may be rejected based at least in part on the collection of tuples containing a mixture of instance identifiers, even if they all use identical bank numbers otherwise. This combination indicates that the host code attempts to mix registers of different host applications in the same query. In some aspects, the query may be rejected based at least in part on the collection including multiple generations of otherwise identical tuples. This collection may be rejected based at least in part on including some history of a register, while the standard TPM API only references the then-current state. Although this collection is to be rejected by the standard TPM API, this combination may add value.

The above security-relevant conditions may be reported (e.g., separately), even if grouped under a more general policy error. For example, host libraries may map the security-relevant conditions to the same TPM error to associated callers. Distinguishing the security-relevant conditions may support proper recovery and reporting.

The possible virtualization-aware addition would extend the TPM quote API to allow reporting history for one or more registers. This addition supports new capabilities by creating a single history describing signed response in a manner otherwise identical to TPM responses. Using a quote-template feature beyond that of the standard TPM API, the system may include a bitmask similar to a local TPM using a register-indicating mask that requests including register history. The backend may collate different generations of the same tuple (register), and report a list that appends a history to the then-current register state. In some aspects, a reporting history may include an additional error condition if generation counters of any history-requested register tuples are not consecutive.

In example implementations of the system, the system may extend a trusted-platform system that maintains a single list of registers to securely manage and report a system state, and in some cases, a history of the system state. The system may virtualize the list of registers with multiple banks (e.g., as parallel lists of registers). Banks of registers may form a two-dimensional register matrix. In some aspects, the system (e.g., the TPM) may maintain a generation counter for each register (e.g., PCR) managed.

In some aspects, tuples of a request (e.g., a register, bank, generation counter) may be further specialized by adding instance-identifier fields (salts or “salt numbers”), which are sufficiently long for practical unicity. The system may assume that (register, bank, generation counter, instance identifier) tuples are practically unique. In some aspects, tuples may be serialized in a non-malleable form and may be integrity-protected against modification by anyone except trust-root management backends. For example, the system may calculate a cryptographic medium access control (MAC) over an otherwise cleartext, host-readable structure. In some aspects, the state-describing tuples may be non-confidential with contents that are available to queries, and may use only integrity protection.

In some aspects, integrity-protected tuples from may be stored on the host. A host adapter library may be expected to manage the tuples, including any maintenance of history, and map TPM services to those operating on tuple-enclosed data. In some aspects, the host library may be aware of the multi-tenant virtualized nature of the backend and may manage storage tuples’ serialized forms, including storing past tuples (e.g., since a compliant TPM client expects a top-level service without service requirements of its own).

In some aspects, the system may provide a sign quote service (e.g., of system status) as a virtualized extension of a trusted-platform signature service. In addition to the query template, calls may also attach the tuples that may be referenced by the template. Inferring the tuples to include from the query template may be decided by the host library from. In some aspects, the host-visible API may provide only the template to the host library.

In some aspects, the backend may receive a query template, and a serialized collection of tuples as a request. After successfully evaluating the template for correctness, and the collection of tuples to correspond to the template without security violations, the backend may form the TPM-compatible query structure (e.g., filled in from tuples’ contents) and respond with a signed response.

In some aspects, the system may reject incorrect request templates or inconsistent template + tuple collections. Additional errors may be added to report error conditions unique to virtualization.

As an optional extension to the standard TPM API, the system may add an extended capability where history of registers may also be reported. This extension may be erroneous in standard time unaware TPMs. However, it may be possible and valuable to report history in a system where a virtualization-aware host is implicitly capable of maintaining history.

Based at least in part on using multi-tenancy of PCRs in a multi-bank VTPM (e.g., TPM-like attestation in a virtualized environment), a system may improve scalability, improve efficiency (e.g., by using a single VTPM system instead of individual VTPM systems per tenant), or support security (e.g., based at least in part on using a virtual library to pass on requests to the VTPM system or using salt numbers, among other examples).

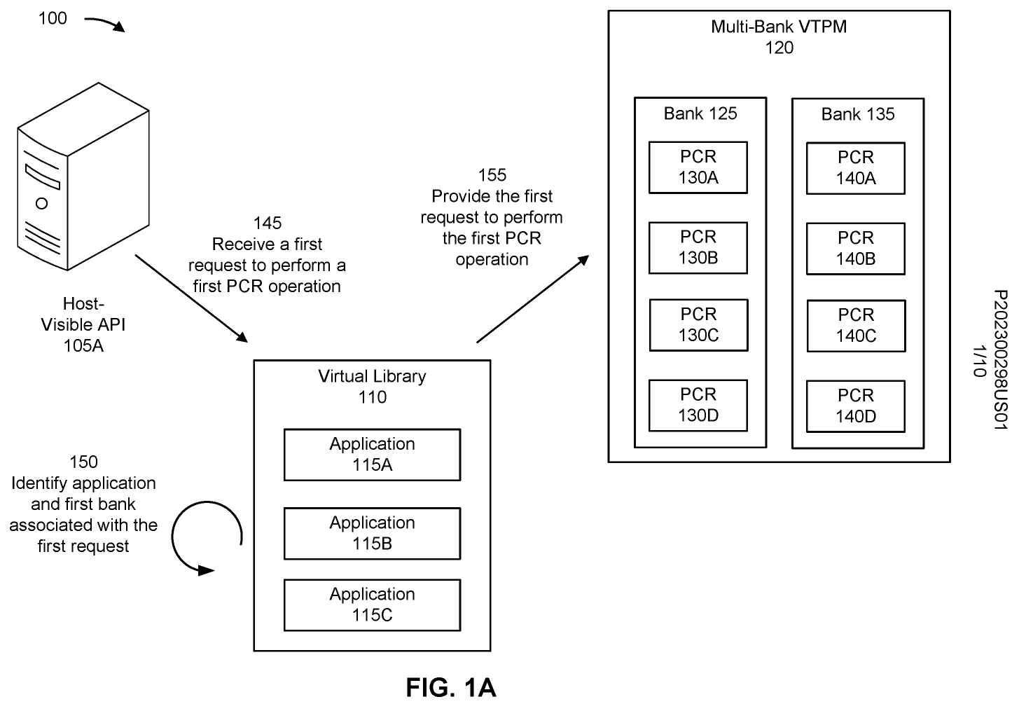

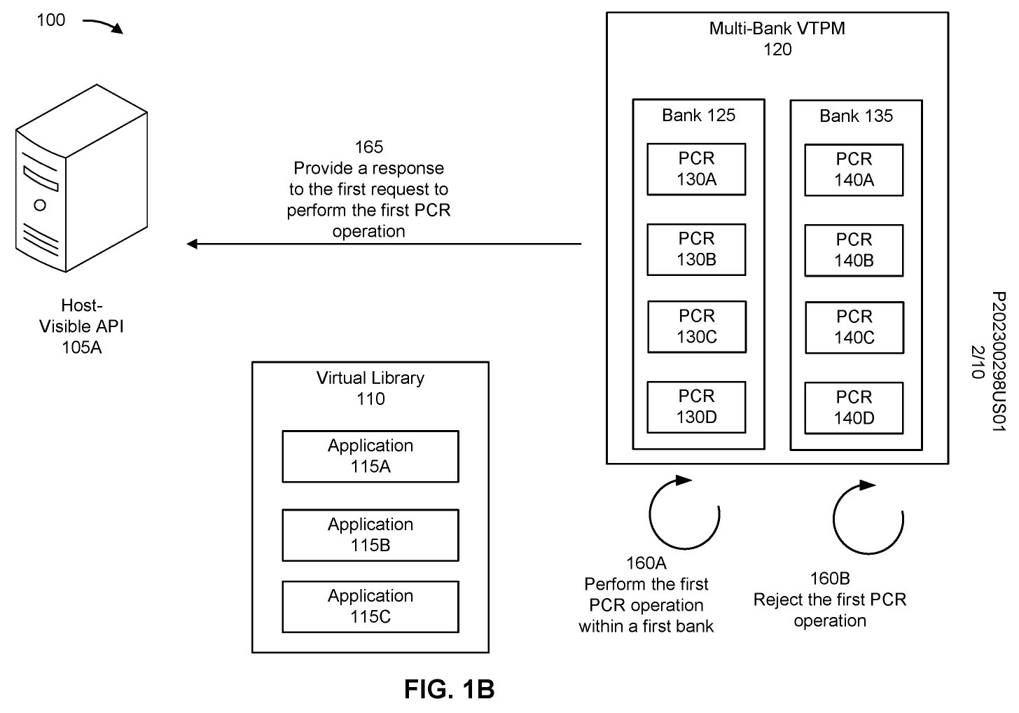

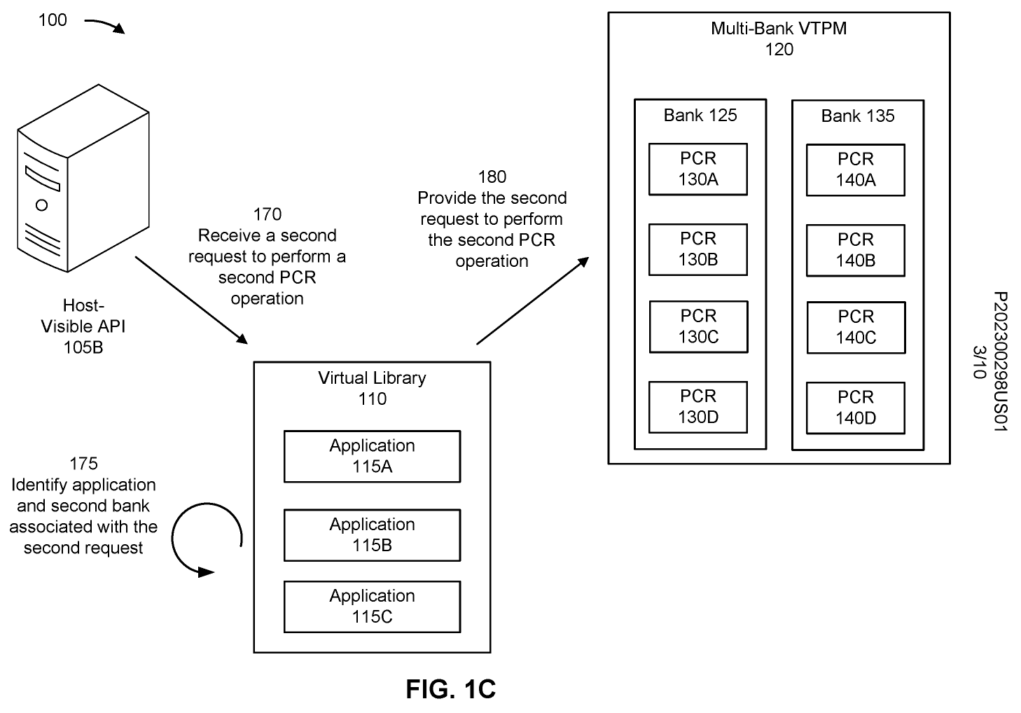

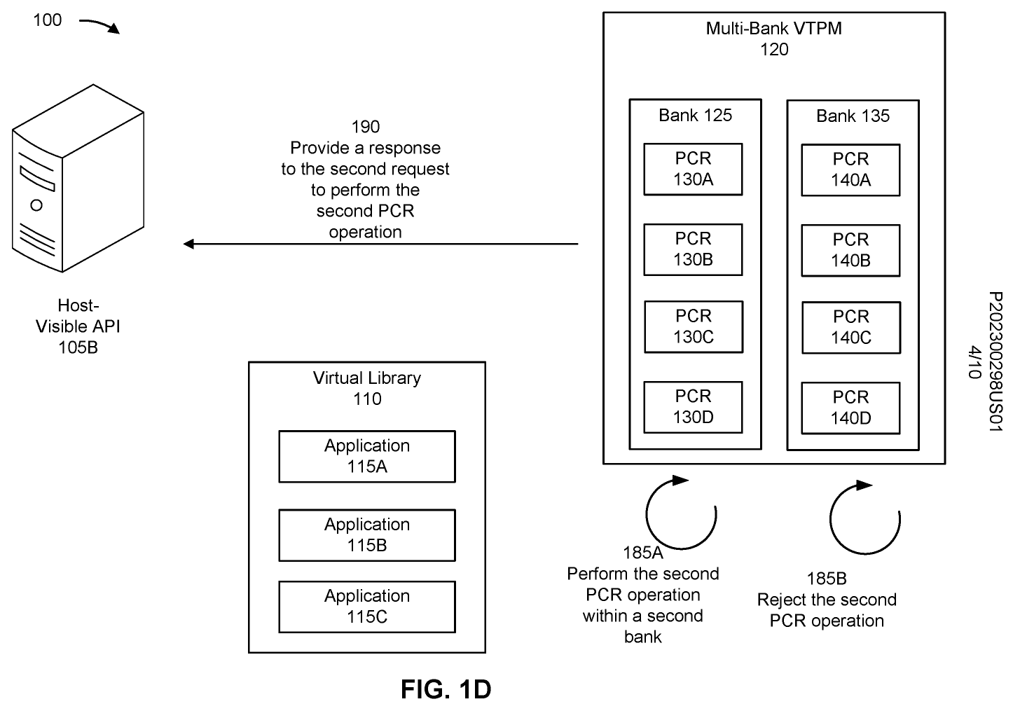

FIGS. 1A-1D are diagrams of an example implementation 100 described herein. As shown in FIGS. 1A-1D, example implementation 100 includes a host-visible API 105 (e.g., an application or other PCR requester), a virtual library 110 servicing attestation services for applications 115A-115C, and a multi-bank VTPM 120 having a bank 125 storing PCRs 130A-130D and a bank 135 storing PCRs 140A-140D.

In some aspects, the virtual library 110 and the multi-bank VTPM 120 may operate in a cloud computing environment, such as a backend service of the cloud computing environment. In some aspects, the cloud computing environment may support virtual machines, including a virtual machine associated with the host-visible API 105.

As shown in FIG. 1A, and by reference number 145, the virtual library 110 may receive, and the host-visible API 105A may provide, a first request to perform a first PCR operation. For example, the host-visible API 105A may provide a request to store a PCR value (e.g., extend the PCR value using a PCR extend operation) associated with a measurement of a first computing device (e.g., a first virtual machine) as a register value. In other examples, the host-visible API 105A may provide a request to verify a PCR value before performing an operation at the first computing device.

As shown by reference number 150, the virtual library 110 may identify an application and first bank associated with the first request. In some aspects, based at least in part on the multi-bank VTPM storing banks associated with different applications, the virtual library 110 may organize requests based at least in part on APIs or applications from which they are received. In some aspects, the virtual library 110 may identify an application 115A, 115B, or 115C associated with the first request or the host visible API 105A. In some aspects, the virtual library 110 may identify the application 115A, 115B, or 115C based at least in part on a salt number or based at least in part on receiving the request from the host-visible API 105A, among other examples. In some aspects, the salt number may include a cryptographic value, and may be located within one or more first numbers of the PCR indicated in the request or an indication in a salt field of the request, among other examples. In some aspects, a first salt number may be associated with a first bank and a second salt number may be associated with a second bank, and so on. In some aspects, the virtual library 110 may reject a request based at least in part on requesting PCRs from multiple banks of the multi-bank VTPM 120.

As shown by reference number 155, the virtual library 110 may provide the first request to perform the first PCR operation to the multi-bank VTPM 120. In some aspects, the virtual library 110 may attach a salt number or another indication of a single bank of the multi-bank VTPM 120 from which the multi-bank VTPM 120 is to perform the first PCR operation. In some aspects, the salt number or the indication of the single bank may be included in the first request as sent by the host-visible API 105A.

As shown in FIG. 1B, and by reference number 160A, the multi-bank VTPM 120 may perform the first PCR operation within a first bank (e.g., bank 125 or bank 135). In some aspects, the multi-bank VTPM 120 may perform the first PCR operation based at least in part on the first PCR operation being associated with one or more PCRs within only one bank. In some aspects, the multi-bank VTPM 120 may perform the first PCR operation on PCR values (e.g., PCR 130A-130D or PCR 140A-140D) indicated in the first request. For example, the multi-bank VTPM 120 may perform the first PCR operation on one or more of the PCR values within a single bank. In some aspects, the first PCR operation may include validating a PCR value from the host-visible API 105A. In some aspects, the first PCR operation may include modifying the PCR value based at least in part on new measurements at a computing device associated with the host-visible API 105A (e.g., during a booting operation). In some aspects where the first PCR operation includes modifying the PCR value, the multi-bank VTPM 120 may store a PCR generation counter (e.g., an indication of a current generation of a PCR value) or one or more previous values of the PCR.

As shown by reference number 160B, the multi-bank VTPM 120 may reject the first PCR operation. In some aspects, the multi-bank VTPM 120 may reject the first PCR operation based at least in part on the first request indicating PCR indices that are not present, indicating PCR indices that are in different banks, indicating PCRs with different instance identifiers, or indicating different generations of PCRs, among other examples.

As shown by reference number 165, the multi-bank VTPM 120 may provide a response to the first request to perform the first PCR operation. In some aspects, the response may include an indication of a rejection of the first PCR operation (e.g., in connection with reference number 160B), or an indication of validity of a PCR (e.g., an attestation response that is positive or negative) or an indication of successful modification of the PCR (e.g., in connection with reference number 160A), among other examples.

As shown in FIG. 1C, and by reference number 170, the virtual library 110 may receive, and a host-visible API 105B may provide, a second request to perform a second PCR operation. Similar to the first request, the host-visible API 105B may provide a request to store a PCR value associated with a measurement of a second computing device (e.g., a second virtual machine) as a register value, or the host-visible API 105B may provide a request to verify a PCR value before performing an operation at the second computing device.

As shown by reference number 175, the virtual library 110 may identify an application and second bank associated with the second request. In some aspects, the virtual library 110 may identify an application 115A, 115B, or 115C associated with the second request or the host visible API 105B. In some aspects, the virtual library 110 may identify the application 115A, 115B, or 115C based at least in part on a salt number (e.g., one or more first numbers of the PCR indicated in the request or an indication in a salt field of the request, among other examples) or based at least in part on receiving the request from the host-visible API 105B, among other examples. As in FIG. 1A, the virtual library 110 may reject a request based at least in part on requesting PCRs from multiple banks of the multi-bank VTPM 120.

As shown by reference number 180, the virtual library 110 may provide the second request to perform the second PCR operation to the multi-bank VTPM 120. As described in connection with reference number 155 for the first request, the virtual library 110 may attach a salt number or another indication of a single bank of the multi-bank VTPM 120 from which the multi-bank VTPM 120 is to perform the second PCR operation. In some aspects, the salt number or the indication of the single bank may be included in the second request as sent by the host-visible API 105A.

As shown in FIG. 1D, and by reference number 185A, the multi-bank VTPM 120 may perform the first PCR operation within a second bank (e.g., bank 125 or bank 135). In some aspects, the multi-bank VTPM 120 may perform the second PCR operation based at least in part on the second PCR operation being associated with one or more PCRs within only one bank. In some aspects, the multi-bank VTPM 120 may perform the first PCR operation on PCR values (e.g., PCR 130A-130D or PCR 140A-140D) indicated in the second request. For example, the multi-bank VTPM 120 may perform the second PCR operation on one or more of the PCR values within a single bank. As described in connection with FIG. 1B, the second PCR operation may include validating a PCR value from the host-visible API 105A or modifying the PCR value based at least in part on new measurements at a computing device associated with the host-visible API 105A (e.g., during a booting operation), among other examples. In some aspects where the second PCR operation includes modifying the PCR value, the multi-bank VTPM 120 may store a PCR generation counter or one or more previous values of the PCR.

As shown by reference number 185B, the multi-bank VTPM 120 may reject the second PCR operation. Similar to reference number 160B, the multi-bank VTPM 120 may reject the second PCR operation based at least in part on the second request indicating PCR indices that are not present, indicating PCR indices that are in different banks, indicating PCRs with different instance identifiers, or indicating different generations of PCRs, among other examples.

As shown by reference number 190, the multi-bank VTPM 120 may provide a response to the second request to perform the second PCR operation. In some aspects, the response may include an indication of a rejection of the second PCR operation (e.g., in connection with reference number 185B), or an indication of validity of PCR or an indication of successful modification of the PCR (e.g., in connection with reference number 185A), among other examples.

As indicated above, FIGS. 1A-1D are provided as an example. Other examples may differ from what is described with regard to FIGS. 1A-1D. The number and arrangement of devices shown in FIGS. 1A-1D are provided as an example.

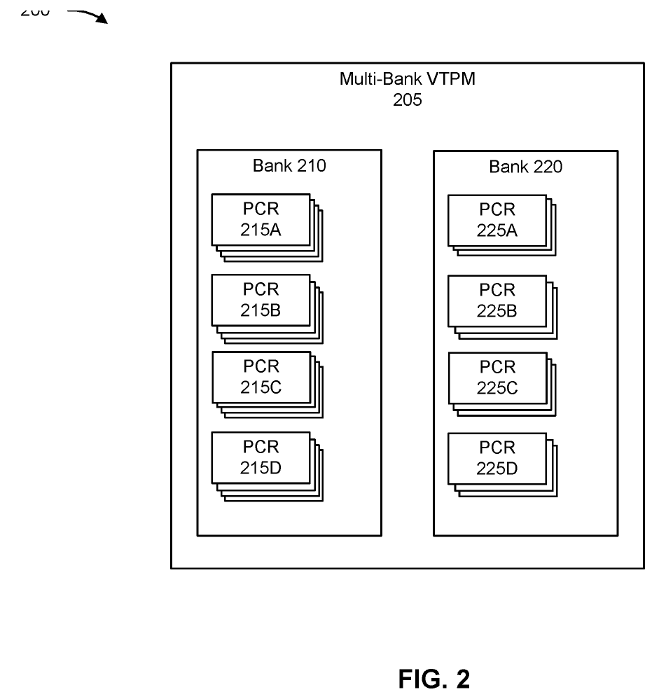

FIG. 2 is a diagram of an example implementation 200 described herein. As shown in FIG. 2, example implementation 200 includes a multi-bank VTPM 205 that stores a bank 210 of PCRs 215A-215D and a bank 220 of PCRs 225A-225D. As shown in FIG. 2, the PCRs 215A-215D and 225A-225D may include data in addition to a current PCR value. In some aspects, the data may include a generation counter (e.g., an index that increases when an associated PCR value is modified). In some aspects, the data may include all or a portion of a previous PCR value. In some aspects, the data may include tuples that include previous PCR values and associated generation numbers.

Based at least in part on storing the generation counter, the multi-bank VTPM 205 may reject a request for a PCR operation based at least in part on indicating an incorrect or outdated generation index. Based at least in part on storing all or a portion of a previous PCR value, the multi-bank VTPM 205 may indicate whether a rejected (e.g., failed) PCR request failed because of a mismatch of generations (e.g., if a PCR value indicated in the request matches an outdated PCR value) or if malware is likely to have cause an invalid PCR number associated with the request.

As indicated above, FIG. 2 is provided as an example. Other examples may differ from what is described with regard to FIG. 2. The number and arrangement of devices shown in FIG. 2 are provided as an example.

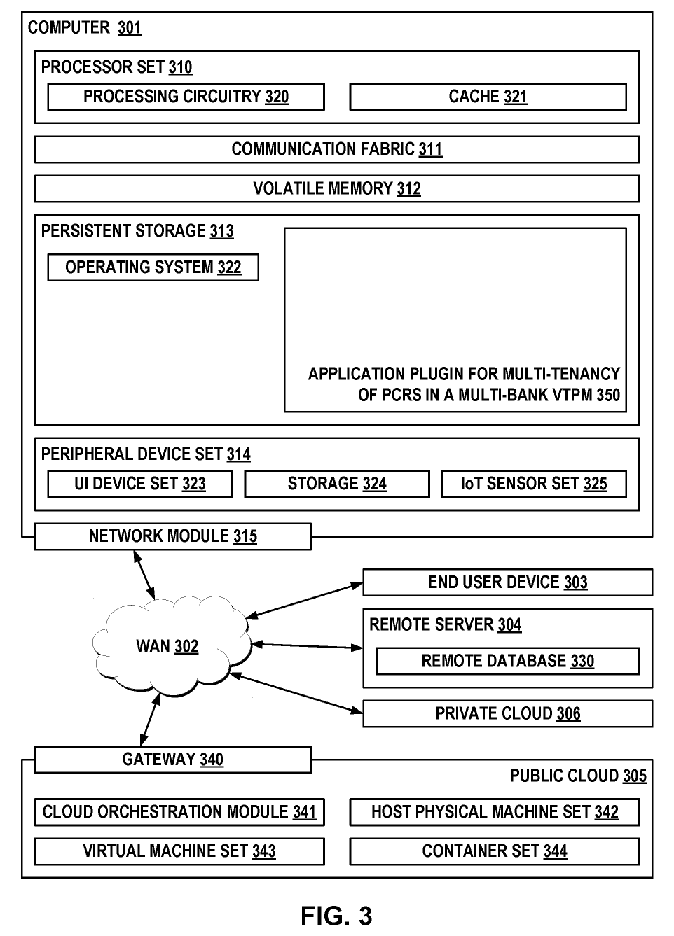

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as application plugin for multi-tenancy of PCRs in a multi-bank VTPM 350. In addition to application plugin for multi-tenancy of PCRs in a multi-bank VTPM 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and application plugin for multi-tenancy of PCRs in a multi-bank VTPM 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in application plugin for multi-tenancy of PCRs in a multi-bank VTPM 350 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in application plugin for multi-tenancy of PCRs in a multi-bank VTPM 350 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

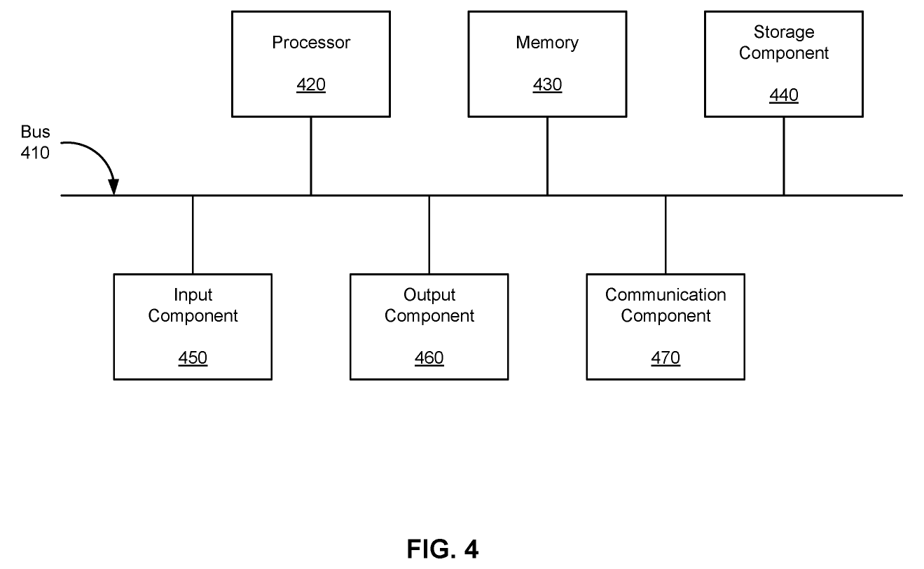

FIG. 4 is a diagram of example components of a device 400, which may correspond to the multi-bank VTPM 120, the multi-bank VTPM 205, or the virtual library 110, among other examples. In some implementations, the computing device 114 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may be a repository that stores a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

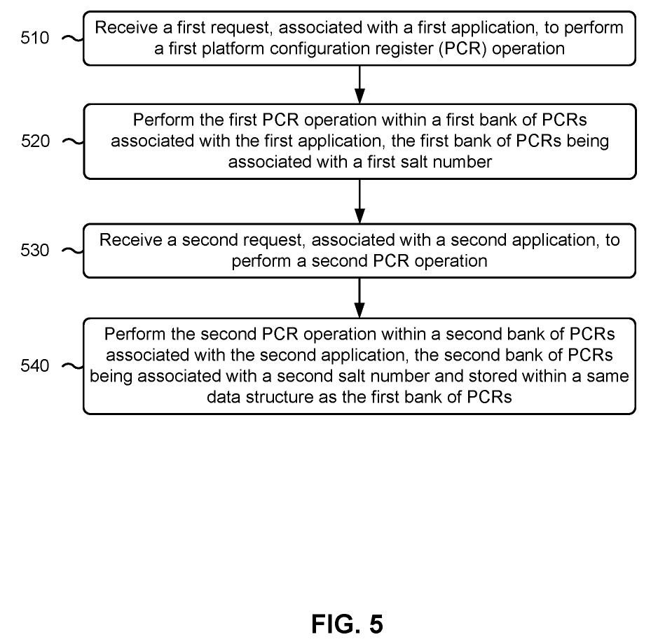

FIG. 5 is a flowchart of an example process 500 associated with multi-tenancy of PCRs in a multi-bank VTPMs. In some implementations, one or more process blocks of FIG. 5 may be performed by a VTPM (e.g., VTPM 120 or 205). In some implementations, one or more process blocks of FIG. 5 may be performed by another device or a group of devices separate from or including the VTPM, such as virtual library 110. Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving a first request, associated with a first application, to perform a first platform configuration register (PCR) operation (block 510). For example, the VTPM may receive a first request, associated with a first application, to perform a first platform configuration register (PCR) operation, as described above.

As further shown in FIG. 5, process 500 may include performing the first PCR operation within a first bank of PCRs associated with the first application, the first bank of PCRs being associated with a first salt number (block 520). For example, the VTPM may perform the first PCR operation within a first bank of PCRs associated with the first application, the first bank of PCRs being associated with a first salt number, as described above.

As further shown in FIG. 5, process 500 may include receiving a second request, associated with a second application, to perform a second PCR operation (block 530). For example, the VTPM may receive a second request, associated with a second application, to perform a second PCR operation, as described above.

As further shown in FIG. 5, process 500 may include performing the second PCR operation within a second bank of PCRs associated with the second application, the second bank of PCRs being associated with a second salt number and being stored within a same data structure as the first bank of PCRs (block 540). For example, the VTPM may perform the second PCR operation within a second bank of PCRs associated with the second application, the second bank of PCRs stored within a same data structure as the first bank of PCRs, as described above.

Process 500 may include additional implementations, such as any single implementation or any combination of implementations described below and/or in connection with one or more other processes described elsewhere herein.

In a first implementation, receiving the first request comprises receiving the first request via a library application.

In a second implementation, alone or in combination with the first implementation, receiving the first request comprises receiving the first request including an indication of a PCR value and a PCR index associated with the first PCR operation.

In a third implementation, alone or in combination with one or more of the first and second implementations, based at least in part on the first salt number and the second salt number, the first PCR bank is accessible to a first application programming interface (API) and the second PCR bank is inaccessible to the first API; and, based at least in part on the first salt number and the second salt number, the second PCR bank is accessible to a second application programming interface (API) and the first PCR bank is inaccessible to the second API

In a fourth implementation, alone or in combination with one or more of the first through third implementations, the first request is associated with a first PCR of the first bank and a second PCR of the first bank, and wherein performing the first PCR operation comprises performing the first PCR operation associated with the first PCR and the second PCR.

In a fifth implementation, alone or in combination with one or more of the first through fourth implementations, the first request is associated with a first PCR of the first bank and a second PCR of the second bank, and wherein performing the first PCR operation comprises performing the first PCR operation associated with the first PCR and not for the second PCR based at least in part on the second PCR being associated with the second bank.

In a sixth implementation, alone or in combination with one or more of the first through fifth implementations, the first PCR comprises an indication of a generation of the first PCR, or the second PCR comprises an indication of a generation of the second PCR.

In a seventh implementation, alone or in combination with one or more of the first through sixth implementations, the first PCR comprises multiple first PCR states associated with different generations of the first PCR, or the second PCR comprises multiple second PCR states associated with different generations of the second PCR.

In an eighth implementation, alone or in combination with one or more of the first through seventh implementations, the first request comprises a request to fill a template with the first PCR, or wherein the second request comprises a request to fill the template with the second PCR.

In a ninth implementation, alone or in combination with one or more of the first through eighth implementations, the first bank and the second bank are stored within a single data structure.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

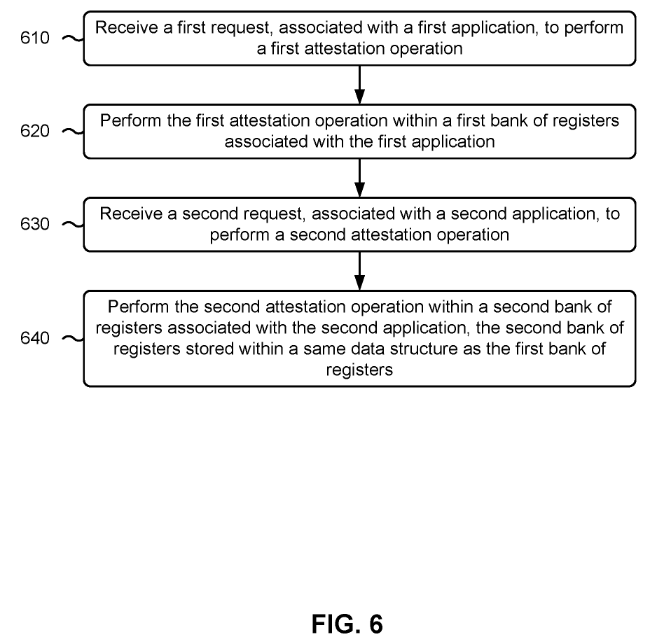

FIG. 6 is a flowchart of an example process 600 associated with multi-tenancy of PCRs in a multi-bank VTPMs. In some implementations, one or more process blocks of FIG. 6 may be performed by a VTPM (e.g., VTPM 120 or 205). In some implementations, one or more process blocks of FIG. 6 may be performed by another device or a group of devices separate from or including the VTPM, such as virtual library 110. Additionally, or alternatively, one or more process blocks of FIG. 6 may be performed by one or more components of device 400, such as processor 420, memory 430, storage component 440, input component 450, output component 460, and/or communication component 470.

As shown in FIG. 6, process 600 may include receiving a first request, associated with a first application, to perform a first attestation operation (block 610). For example, the VTPM may receive a first request, associated with a first application, to perform a first attestation operation, as described above.

As further shown in FIG. 6, process 600 may include performing the first attestation operation within a first bank of registers associated with the first application (block 620). For example, the VTPM may perform the first attestation operation within a first bank of registers associated with the first application, as described above.

As further shown in FIG. 6, process 600 may include receiving a second request, associated with a second application, to perform a second attestation operation (block 630). For example, the VTPM may receive a second request, associated with a second application, to perform a second attestation operation, as described above.

As further shown in FIG. 6, process 600 may include performing the second attestation operation within a second bank of registers associated with the second application, the second bank of registers stored within a same data structure as the first bank of registers (block 640). For example, the VTPM may perform the second attestation operation within a second bank of registers associated with the second application, the second bank of registers stored within a same data structure as the first bank of registers, as described above.

Process 600 may include additional implementations, such as any single implementation or any combination of implementations described below and/or in connection with one or more other processes described elsewhere herein.

In a first implementation, the first bank is associated with a first salt number and the second bank is associated with a second salt number.

In a second implementation, alone or in combination with the first implementation, the first request indicates the first salt number within a salt field of the first request or as one or more numbers of an indication of a state of a device associated with the first application, or wherein the second request indicates the second salt number within a salt field of the second request or as one or more numbers of an indication of a state of a device associated with the second application.

In a third implementation, alone or in combination with one or more of the first and second implementations, the first request comprises one or more of a first register value, a first register index, or a generation index associated with the first register value.

In a fourth implementation, alone or in combination with one or more of the first through third implementations, process 600 includes providing an attestation response to the attestation request.

In a fifth implementation, alone or in combination with one or more of the first through fourth implementations, process 600 includes registering indexes present within the first bank, indications associated with the first bank and not the second bank for all registers indicated in the first request, indications of a same instance for all registers indicated in the first request, or indications of a same generational index for all registers indicated in the first request.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

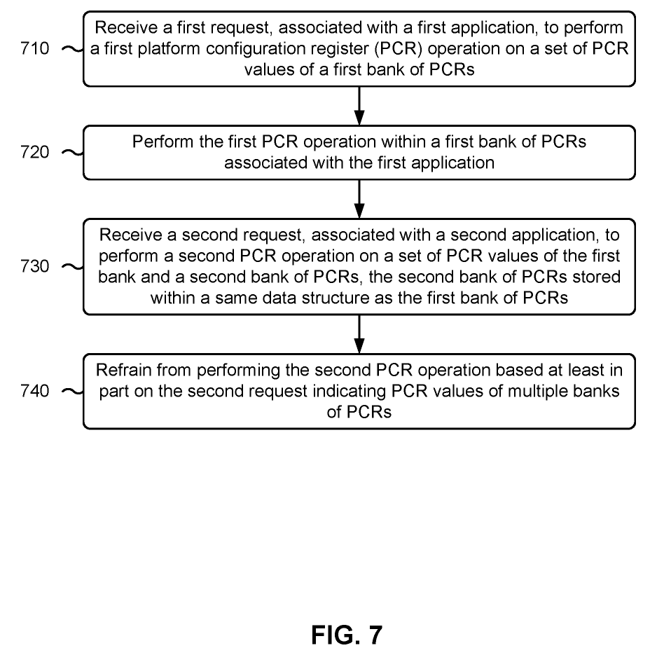

FIG. 7 is a flowchart of an example process 700 associated with multi-tenancy of PCRs in a multi-bank VTPMs. In some implementations, one or more process blocks of FIG. 7 may be performed by a VTPM (e.g., VTPM 120 or 205). In some implementations, one or more process blocks of FIG. 7 may be performed by another device or a group of devices separate from or including the VTPM, such as virtual library 110. Additionally, or alternatively, one or more process blocks of FIG. 7 may be performed by one or more components of device 400, such as processor 420, memory 430, storage component 440, input component 450, output component 460, and/or communication component 470.

As shown in FIG. 7, process 700 may include receiving a first request, associated with a first application, to perform a first platform configuration register (PCR) operation on a set of PCR values of a first bank of PCRs (block 710). For example, the VTPM may receive a first request, associated with a first application, to perform a first platform configuration register (PCR) operation on a set of PCR values of a first bank of PCRs, as described above.

As further shown in FIG. 7, process 700 may include performing the first PCR operation within a first bank of PCRs associated with the first application (block 720). For example, the VTPM may perform the first PCR operation within a first bank of PCRs associated with the first application, as described above.

As further shown in FIG. 7, process 700 may include receiving a second request, associated with a second application, to perform a second PCR operation on a set of PCR values of the first bank and a second bank of PCRs, the second bank of PCRs stored within a same data structure as the first bank of PCRs (block 730). For example, the VTPM may receive a second request, associated with a second application, to perform a second PCR operation on a set of PCR values of the first bank and a second bank of PCRs, the second bank of PCRs stored within a same data structure as the first bank of PCRs, as described above.

As further shown in FIG. 7, process 700 may include refraining from performing the second PCR operation based at least in part on the second request indicating PCR values of multiple banks of PCRs (block 740). For example, the VTPM may refrain from performing the second PCR operation based at least in part on the second request indicating PCR values of multiple banks of PCRs, as described above.

Process 700 may include additional implementations, such as any single implementation or any combination of implementations described below and/or in connection with one or more other processes described elsewhere herein.

In a first implementation, the first request comprises one or more of a first PCR value, a first PCR index, or a generation index associated with the first PCR value.

In a second implementation, alone or in combination with the first implementation, the first application is associated with a first virtual machine, and wherein the second application is associated with a second virtual machine.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a first request, associated with a first application, to perform a first platform configuration register (PCR) operation;
performing the first PCR operation within a first bank of PCRs associated with the first application, the first bank of PCRs being associated with a first salt number;
receiving a second request, associated with a second application, to perform a second PCR operation; and
performing the second PCR operation within a second bank of PCRs associated with the second application, the second bank of PCRs being associated with a second salt number and being stored within a same data structure as the first bank of PCRs.

2. The method of claim 1, wherein receiving the first request comprises:
receiving the first request via a library application.

3. The method of claim 1, wherein receiving the first request comprises:
receiving the first request including an indication of a PCR value and a PCR index associated with the first PCR operation.

4. The method of claim 1, wherein, based at least in part on the first salt number and the second salt number, the first PCR bank is accessible to a first application programming interface (API) and the second PCR bank is inaccessible to the first API, and
wherein, based at least in part on the first salt number and the second salt number, the second PCR bank is accessible to a second application programming interface (API) and the first PCR bank is inaccessible to the second API.

5. The method of claim 1, wherein the first request is associated with a first PCR of the first bank and a second PCR of the first bank, and
wherein performing the first PCR operation comprises performing the first PCR operation associated with the first PCR and the second PCR.

6. The method of claim 1, wherein the first request is associated with a first PCR of the first bank and a second PCR of the second bank, and
wherein performing the first PCR operation comprises performing the first PCR operation associated with the first PCR and not for the second PCR based at least in part on the second PCR being associated with the second bank.

7. The method of claim 1, wherein the first PCR comprises an indication of a generation of the first PCR, or
wherein the second PCR comprises an indication of a generation of the second PCR.

8. The method of claim 1, wherein the first PCR comprises multiple first PCR states associated with different generations of the first PCR, or
wherein the second PCR comprises multiple second PCR states associated with different generations of the second PCR.

9. The method of claim 1, wherein the first request comprises a request to fill a template with the first PCR, or
wherein the second request comprises a request to fill the template with the second PCR.

10. The method of claim 1, wherein the first bank and the second bank are stored within a single data structure.

11. A computer program product comprising:
one or more computer readable storage media, and program instructions collectively stored on the one or more computer readable storage media, the program instructions comprising:
program instructions to receive a first request, associated with a first application, to perform a first attestation operation;
program instructions to perform the first attestation operation within a first bank of registers associated with the first application;
program instructions to receive a second request, associated with a second application, to perform a second attestation operation; and
program instructions to perform the second attestation operation within a second bank of registers associated with the second application, the second bank of registers stored within a same data structure as the first bank of registers.

12. The computer program product of claim 11, wherein the first bank is associated with a first salt number and the second bank is associated with a second salt number.

13. The computer program product of claim 12, wherein the first request indicates the first salt number within a salt field of the first request or as one or more numbers of an indication of a state of a device associated with the first application, or
wherein the second request indicates the second salt number within a salt field of the second request or as one or more numbers of an indication of a state of a device associated with the second application.

14. The computer program product of claim 12, wherein the first request comprises one or more of:
a first register value,
a first register index, or
a generation index associated with the first register value.

15. The computer program product of claim 12, wherein the program instructions comprise:
program instructions to provide an attestation response to the attestation request.

16. The computer program product of claim 12, wherein the program instructions comprise program instructions to perform the first attestation request based at least in part on the first attestation request indicating one or more of:
register indexes present within the first bank,
indications associated with the first bank and not the second bank for all registers indicated in the first request,
indications of a same instance for all registers indicated in the first request, or
indications of a same generational index for all registers indicated in the first request.

17. A system comprising:
one or more devices configured to:
receive a first request, associated with a first application, to perform a first platform configuration register (PCR) operation on a set of PCR values of a first bank of PCRs;
perform the first PCR operation within a first bank of PCRs associated with the first application;
receive a second request, associated with a second application, to perform a second PCR operation on a set of PCR values of the first bank and a second bank of PCRs, the second bank of PCRs stored within a same data structure as the first bank of PCRs; and
refrain from performing the second PCR operation based at least in part on the second request indicating PCR values of multiple banks of PCRs.

18. The system of claim 17, wherein the one or more devices comprise a virtual trusted platform module.

19. The system of claim 17, wherein the first request comprises one or more of:
a first PCR value,
a first PCR index, or
a generation index associated with the first PCR value.

20. The system of claim 17, wherein the first application is associated with a first virtual machine, and
wherein the second application is associated with a second virtual machine.
